(19) United States
(12) Patent Application Publication
(10) Pub. No.: US 2023/0241972 A1
(43) Pub. Date: Aug. 3, 2023

(54) METHOD FOR DEPICTING A VEHICLE IN AN ANIMATED, THREE-DIMENSIONAL MANNER

(71) Applicant: Robert Bosch GmbH, Stuttgart (DE)

(72) Inventors: Jose Domingo Esparza Garcia, Stuttgart (DE); Raphael Cano, Stuttgart (DE)

(21) Appl. No.: 17/998,326

(22) PCT Filed: Jun. 17, 2021
(86) PCT No.: PCT/EP2021/066398

§ 371 Date: Nov. 9, 2022

(30) Foreign Application Priority Data
Jul. 3, 2020 (DE) 10 2020 208 363.0

(51) Int. Cl. B60K 35/00; G06T 13/20

(52) U.S. Cl. CPC B60K 35/00; G06T 13/20; B60K 2370/167; B60K 2370/171

(57) ABSTRACT

A method for depicting a vehicle in an animated, three-dimensional manner. The method includes: animating a body of the vehicle in three dimensions; animating at least one wheel of the vehicle independently of the animation of the body; determining a current acceleration of the vehicle to be animated; determining a current pitch angle depending on the current acceleration and on vehicle parameters characterizing the pitch angle; animating a pitch movement of the animated body relative to the at least one animated wheel using the current pitch angle, for depicting body dynamics of the vehicle in an animated manner.

### BACKGROUND INFORMATION

Automation of driving involves equipping vehicles with increasingly extensive and powerful sensor systems for capturing and depicting the surroundings.

The surroundings of the vehicle in question are depicted using a surround-view system (SVS), in which 3D vehicle models are generated, the vehicle models being depicted in great detail in a surround view. Certain assemblies in the vehicle model are animated independently of one another, such as the wheel, for which the number of revolutions is adapted to the speed or of which the position in space is adapted to the steering angle; furthermore, turn signals, the doors, or the vehicle lights can be animated. The aim of current 3D surround systems is to assist the driver with maneuvers, such as parking maneuvers.

### SUMMARY

To improve such a 3D vehicle model for surround-view systems, according to the present invention, it is provided that a body of the 3D vehicle model be dynamically animated in order to make the depiction in a 3D surround-view function appear more realistic.

Aspects of the present invention provide a method for depicting a vehicle in an animated, three-dimensional manner, an animation device, the use of the method, a computer program, and a machine-readable storage medium. Advantageous example embodiments of the present invention are disclosed herein.

Throughout this description, the order of method steps is such that the method can be easily understood. However, a person skilled in the art will recognize that many of the method steps can also be performed in a different order and will provide an identical or corresponding result. With this in mind, the order of the method steps can be changed accordingly without the method being changed. Some features are provided with classifiers to improve readability or make the relationships clearer, but this does not imply the presence of certain features.

According to one aspect of the present invention, a method for depicting a vehicle in an animated, three-dimensional manner is provided. According to an example embodiment of the present invention, the method includes the following steps:

In one step, a body of the vehicle is animated in three dimensions. In a further step, at least one wheel of the vehicle is animated independently of the animation of the body. In a further step, a current acceleration of the vehicle to be animated is determined. In a further step, a current pitch angle is determined depending on the current acceleration and on vehicle parameters characterizing the pitch angle. In a further step, a pitch movement of the animated body relative to the at least one animated wheel is animated using the current pitch angle in order to obtain an animated depiction of body dynamics of the vehicle.

The term or feature “vehicle” should be interpreted broadly in this context. A vehicle of this kind can be a manually driven vehicle, and in particular an at least partially automated vehicle or a vehicle comprising a driver-assistance system. In this case, the term “vehicle” covers all wheel-driven machines and/or chain-driven machines and/or machines driven in a different ground-based manner which are parked in a manual, partially automated, or completely automated manner in a parking lot, at least temporarily.

Using this method, the body dynamics of the vehicle are included in the 3D vehicle model. For the body dynamics, the pitch angle and, as described below, a roll angle of the vehicle as well as a yaw angle, or a combination of these three angles, can be included in the animation. To determine these angles, a simplified vehicle dynamics model based on signals for an acceleration and/or deceleration and a steering angle of the vehicle can be taken as a basis. In this process, the acceleration and/or deceleration can be determined via a sequence of speeds of the vehicle, for example. These signals can be provided by a vehicle bus, such as a CAN bus or a Flexray bus. On the basis of these signals, rigid-body dynamics of the vehicle can be determined, at least in a simplified manner.

In this process, in the simplified vehicle dynamics model, the pitch angle is inversely proportional to the estimated acceleration and the roll angle is proportional to a function of the current steering angle and the current speed value.

To implement this model in the surround-view application, the vehicle wheel is decoupled from the body by calculating an additional matrix transformation for the body or vehicle structure which does not include the wheels, or the at least one wheel, of the vehicle.

In each update frame of the animation, an acceleration value can be estimated on the basis of the current speed and the previous speed value, so that a rigid rotation matrix which depicts the estimated roll, pitch, and yaw angle values can be defined on the basis of speed, steering, and acceleration values.

Advantageously, by way of the additional animation of the dynamics of the vehicle body, a more realistic animation of the vehicle is obtained which also avoids the impression of a “flying carpet” for the animated vehicle, in which a vehicle always remains parallel to the ground, such as a road, which does not fit with a user’s perceptions. By using a simplified vehicle dynamics model, the calculation of the animation is simplified. Vehicle parameters that are characteristic of a pitch angle, roll angle, or yaw angle are the vehicle parameters required to calculate these angles in a complex vehicle dynamics model and/or a simplified vehicle dynamics model, as described here, from the current values for the acceleration, the speed, or the steering angle of the vehicle. Owing to the much more realistic vehicle movements described here, including the dynamics of the body, the animation provides much more realistic vehicle movements, corresponding to real-world movements. The visual feedback from the surround view has a more realistic appearance when a dynamic vehicle model is used for the body, and therefore improves the confidence in the depiction of the vehicle in the system.

According to one aspect of the present invention, it is provided that the animated three-dimensional depiction of the vehicle is integrated in a surround-view system of a vehicle.

In particular by way of the animation of the vehicle dynamics of the body of the vehicle, an improved and more realistic depiction of the vehicle can be obtained in the surround-view system.

According to one aspect of the present invention, it is provided that the current acceleration of the vehicle is determined from a series of speed values of the vehicle.

Such a series of speed values, in particular an up-to-date series of these speed values, results in the most realistic possible impression of the animated vehicle; here, the series of speed values can consist of two successive speed values that are as up to date as possible such that the calculation can be carried out in a simple manner.

According to one aspect of the present invention, it is provided that the pitch angle is determined in an inversely proportional manner to the determined acceleration.

Using such a simplified model for the vehicle dynamics, the calculation of the animation can be simplified.

According to one aspect of the present invention, it is provided that the pitch movement is animated by depicting a change in the relative distance between the animated three-dimensional body and the at least one animated wheel.

By changing this relative distance on the basis of the pitch movement, the corresponding impression of vehicle dynamics, including dynamics of the body, can be obtained.

According to one aspect of the present invention, the method for depicting a vehicle in an animated, three-dimensional manner comprises the following additional steps:

In one step, a current steering angle of the vehicle is determined. In a further step, a current roll angle of the vehicle is determined using the current steering angle and the current speed of the vehicle. In a further step, a roll movement of the animated body relative to the at least one animated wheel is animated, for the animated three-dimensional depiction of the vehicle.

The additional animation of the roll angle of the vehicle improves the animation of the dynamics of the body and thus of the entire vehicle beyond the animated depiction using the pitch angle.

According to one aspect of the present invention, it is provided that the roll movement is animated by depicting a change in the relative distance between the animated body and the at least one animated wheel.

By changing this relative distance on the basis of the roll movement, the corresponding impression of vehicle dynamics, including dynamics of the body, can be obtained.

According to one aspect of the present invention, the method for depicting a vehicle in an animated, three-dimensional manner comprises the following additional steps:

In one step, a current steering angle of the vehicle is determined. In a further step, a current yaw angle of the vehicle is determined using the current steering angle of the vehicle. In a further step, a yaw movement of the animated body (110) about a vertical axis of the body is animated, for depicting body dynamics of the vehicle in an animated manner.

In this process, in a simple model for the vehicle dynamics, the yaw angle of the body can be determined proportionally to the steering angle of the vehicle. Here, the vertical axis of the body is typically arranged above the rear axle. The additional animation of the yaw angle of the vehicle improves the animation of the dynamics of the body and thus of the entire vehicle beyond the animated depiction using the pitch angle and/or the roll angle.

According to one aspect of the present invention, it is provided that the at least one animated wheel depicts a rotational movement using the series of speed values.

By depicting a rotating wheel using corresponding current speed values, the animated depiction of the vehicle is improved further.

According to one aspect of the present invention, it is provided that the pitch angle and/or the roll angle is/are determined by taking into account a selected hydraulic suspension of the vehicle, and/or a depicted height of the animated body above the ground is adapted to the selected hydraulic suspension of the vehicle.

This means that the animation of the vehicle can be adapted to the current and/or desired properties of the vehicle.

According to one aspect of the present invention, it is provided that the selected hydraulic suspension depicts the vehicle mode currently selected by the driver.

This means that the animation of the vehicle can be automatically adapted to the different driving modes of the real vehicle. Such a selected driving mode relates to a sport mode and/or an off-road mode, for example, and can thus correspond to the mode selected by the driver.

According to one aspect of the present invention, it is provided that a type of the animated body of the vehicle is selected from a list by a user.

Such a list of animated bodies for a vehicle can be provided in an online app store, for example, so that the user of the vehicle has the option of tuning the 3D model of the surround view, for example to low-rider models.

An animation device is proposed which is configured to carry out one of the above-described methods.

Using such an animation device, the method can be easily integrated in different vehicles.

The present invention provides the use of an animated depiction of the three-dimensional vehicle model, corresponding to one of the above-described methods, in a surround-view system.

The present invention includes a computer program comprising commands which, when the computer program is executed by a computer, cause said computer to perform one of the above-described methods. Such a computer program makes it possible to use the described method in different systems.

According to an example embodiment of the present invention, a machine-readable storage medium is provided on which the above-described computer program product is stored. By way of such a machine-readable storage medium, the above-described computer program is transportable.

### BRIEF DESCRIPTION OF THE DRAWINGS

Exemplary embodiments of the present invention are shown and explained in greater detail in the following with reference to the figures.

FIGS. 1A-1C schematically show a pitch movement of a vehicle.

FIGS. 2A-2C schematically show a roll movement of a vehicle.

### DETAILED DESCRIPTION OF EXAMPLE EMBODIMENTS

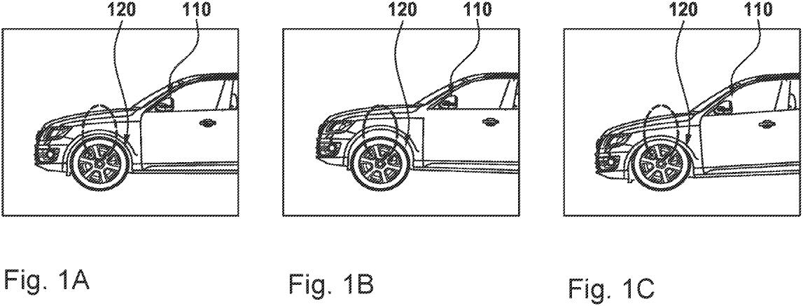

FIGS. 1A to 1C schematically show a pitch movement of a vehicle in which the distance between the body 110 and the wheel 120 varies. In FIG. 1A, the distance between the body 110 and the wheel 120 corresponds to a normal state of the vehicle. FIG. 1B shows how the distance between the body 110 and the wheel 120 increases during positive acceleration. Accordingly, FIG. 1C shows how the distance between the body 110 of the vehicle and the wheel 120 is reduced when the vehicle is braked or negatively accelerated. Therefore, dynamics of the body of the vehicle are depicted on the basis of the change in this distance between the body 110 and the wheel 120.

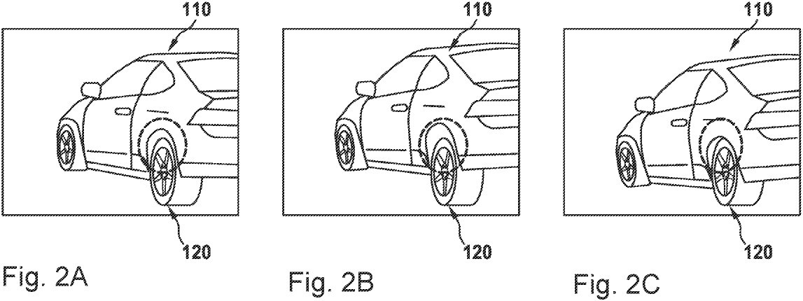

FIGS. 2A to 2C schematically show a roll movement of a vehicle, the distance between the body 110 and both wheels 120 on one side of the vehicle being affected during the roll movement. FIG. 2A shows the normal distance between the body of the vehicle 110 and the wheels 120. On the basis of the position of the front left wheel, it can be seen in FIG. 2B that the vehicle is making a turn to the left, with the corresponding roll movement, which results in an increased roll angle for the left-hand side of the vehicle, which is apparent from the increased distance from the front and rear wheel 120 to the body 110. When making a turn in the other direction, i.e., making a turn to the right, it can be seen from FIG. 2C that the distance between the body 110 and the wheels on the left-hand side of the vehicle is then reduced, in order to depict the dynamics of the vehicle and in particular of the vehicle body.

1-15. (canceled)

16. A method for depicting a vehicle in an animated, three-dimensional manner, comprising the following steps:
animating a body of the vehicle in three dimensions;
animating at least one wheel of the vehicle independently of the animation of the body;
determining a current acceleration of the vehicle to be animated;
determining a current pitch angle depending on the current acceleration and on vehicle parameters characterizing the pitch angle; and
animating a pitch movement of the animated body relative to the at least one animated wheel using the current pitch angle, for the animated depiction of body dynamics of the vehicle.

17. The method as recited in claim 16, wherein the animated three-dimensional depiction of the vehicle is integrated in a surround-view system of a vehicle.

18. The method as recited in claim 16, wherein the current acceleration of the vehicle is determined from a series of speed values of the vehicle.

19. The method as recited in claim 16, wherein the current pitch angle is determined in an inversely proportional manner to the determined current acceleration.

20. The method as recited in claim 16, wherein the pitch movement is animated by depicting a change in a relative distance between the animated body and the at least one animated wheel.

21. The method as recited in claim 16, further comprising the following steps:
determining a current steering angle of the vehicle;
determining a current roll angle of the vehicle using the current steering angle and a current speed of the vehicle; and
animating a roll movement of the animated body relative to the at least one animated wheel, for the animated depiction of body dynamics of the vehicle.

22. The method as recited in claim 21, wherein the roll movement is animated by depicting a change in a relative distance between the animated body and the at least one animated wheel.

23. The method as recited in claim 16, further comprising the following steps:
determining a current steering angle of the vehicle;
determining a current yaw angle of the vehicle using the current steering angle of the vehicle; and
animating a yaw movement of the animated body about a vertical axis of the body, for the animated depiction of body dynamics of the vehicle.

24. The method as recited in claim 18, wherein the at least one animated wheel depicts a rotational movement using the series of speed values.

25. The method as recited in claim 21, further comprising:
determining a current steering angle of the vehicle;
determining a current yaw angle of the vehicle using the current steering angle of the vehicle; and
animating a yaw movement of the animated body about a vertical axis of the body, for the animated depiction of body dynamics of the vehicle
wherein the pitch angle and/or the roll angle is determined by taking into account a selected hydraulic suspension of the vehicle, and/or a depicted height of the animated body above the ground is adapted to the selected hydraulic suspension of the vehicle.

26. The method as recited in claim 25, wherein the selected hydraulic suspension depicts the vehicle mode currently selected by the driver.

27. The method as recited in claim 16, wherein a type of the animated body of the vehicle is selected from a list by a user.

28. An animation device configured to depict a vehicle in an animated, three-dimensional manner, the animation device configured to:
animate a body of the vehicle in three dimensions;
animate at least one wheel of the vehicle independently of the animation of the body;
determine a current acceleration of the vehicle to be animated;
determine a current pitch angle depending on the current acceleration and on vehicle parameters characterizing the pitch angle; and
animate a pitch movement of the animated body relative to the at least one animated wheel using the current pitch angle, for the animated depiction of body dynamics of the vehicle.

29. The animation device recited in claim 28, wherein the animated depiction of the three-dimensional vehicle model is used in a surround-view system.

30. A non-transitory machine-readable medium on which is stored a computer program for depicting a vehicle in an animated, three-dimensional manner, the computer program, when executed by a computer, causing the computer to perform the following steps:
animating a body of the vehicle in three dimensions;
animating at least one wheel of the vehicle independently of the animation of the body;
determining a current acceleration of the vehicle to be animated;
determining a current pitch angle depending on the current acceleration and on vehicle parameters characterizing the pitch angle; and
animating a pitch movement of the animated body relative to the at least one animated wheel using the current pitch angle, for the animated depiction of body dynamics of the vehicle.
